(19) United States
(12) Patent Application Publication
(10) Pub. No.: US 2016/0161024 A1
(43) Pub. Date: Jun. 9, 2016

(54) METHOD AND SYSTEM FOR SUPPORTING SUBMERGED STRUCTURES

(71) Applicant: SUBCON TECHNOLOGIES PTY LTD., Western Australia (AU)

(72) Inventors: Matthew ALLEN, Kensington, Western Australian (AU); James HALLAM, East Fremantle, Western Australia (AU)

(73) Assignee: SUBCON TECHNOLOGIES PTY LTD., Belmont, Western Australia (AT)

(21) Appl. No.: 14/911,832

(22) PCT Filed: Aug. 13, 2014
(86) PCT No.: PCT/AU2014/000803

§ 371 Date: Feb. 12, 2016

(30) Foreign Application Priority Data
Aug. 13, 2013 (AU) 2013903051

(51) Int. Cl. F16L 1/20; F16L 1/12

(52) U.S. Cl. CPC F16L 1/20; F16L 1/123

(57) ABSTRACT

A system and associated method is provided for supporting a submerged structure on an underwater floor. The system incorporates an inflatable container, a submergible supply of a settable composition and a submergible transfer system operable to transfer the settable composition from the supply to the container. The system is arranged so that the supply is subjected to a hydrostatic pressure in the order of that acting on the inflatable container.

### TECHNICAL FIELD

A system and method are disclosed for supporting a submerged structure. In particular but not exclusively, the system and method are applicable to supporting a submerged conduit on an underwater floor. A settable composition for use in the system and method is also disclosed.

### BACKGROUND ART

Submerged conduits are used for many and varied purposes including: to convey fluids such as but not limited to oil and gas; and, to carry communication channels such as metallic cables and optical fibres. The conduits are laid on an underwater floor such as a seabed. A free span of the conduit may occur when the conduit crosses a pre-existing depression in the seabed or when the action of water or currents flowing adjacent to the conduit cause scouring of the seabed leading to the creation of a hollow or depression beneath the conduit. Gravity tends to push or bend the conduit into the hollow. Additionally, currents can cause vortex induced vibrations in the conduit. Each of these has undesirable effects on a free span that may cause failure in a conduit with potentially catastrophic consequences.

For the above reasons submerged conduits are regularly inspected to ascertain the existence and location of hollows. If a hollow is detected, depending on its size, it may be either monitored for growth or subjected to remedial action. For conduits lying in water of a depth less than about 200 m, a diver is able to place a bag in the hollow beneath the conduit. Grout is pumped from a surface vessel into the bag to fill or pack the hollow and consequently support the conduit. Generally divers are not able to operate at depths great than 200 m. In such instances a ROV is used to place the bag in the hollow. But at depths greater than about 350 m a further technical issue arises. The pumping of grout from a surface vehicle becomes technically complicated and inefficient because of the head of water that must overcome for the pump to deliver the grout to the bag. Therefore at depths greater than about 350 m a mechanical jack similar to that used for jacking a passenger road vehicle is used to support the conduit. The jack is manoeuvred into the hollow and operated by a ROV.

The above references to the background art do not constitute an admission that the art forms a part of the common general knowledge of a person of ordinary skill in the art. Further, the above references are not intended to limit the application of the method and system as disclosed herein.

### SUMMARY OF THE DISCLOSURE

Broadly and generally a method and system are disclosed enabling the supporting of a submerged structure by in-situ inflation of an inflatable container with a settable composition. The general idea is to provide the supply of settable composition near the inflatable container and conduit. As such, the settable composition can be subjected to substantially the same (but not necessarily identical) hydrostatic pressure as in the inflatable container. This alleviates the technical problems associate with the static pressure differential between a supply of material at atmospheric pressure and a submerged container to be inflated with that material.

In one aspect there is disclosed a method for supporting a submerged structure on an underwater floor comprising:
disposing an inflatable container to lie between the submerged structure and the underwater floor; and
inflating the inflatable container with a settable composition from a submerged supply of the settable composition.

In one embodiment inflating the inflatable container comprises subjecting the supply of the settable to a hydrostatic pressure in the order of, or substantially the same as, that acting on the inflatable container.

In one embodiment inflating the inflatable container comprises submerging a transfer system and associating the transfer system with the supply to selectively enable transfer of the settable composition from the supply to the inflatable container.

In one embodiment the method comprises applying a slight over pressure to the supply effective such that in an event of a leak between the supply and the transfer system water is prevented by virtue of the slight over pressure from entering the supply or conduits providing fluid communication between the supply and the transfer system.

In one embodiment applying a slight over pressure comprises providing an over pressure in the order of about ½ bar.

In one embodiment the method comprises operating a ROV to remotely connect or disconnect the supply and the container.

In one embodiment the method comprises operating the ROV to control one or more valves provided in conduits facilitating fluid connection between the supply and the inflatable container.

In one embodiment the method comprises operating the ROV to operate the transfer system to facilitate transfer of the settable composition to the container.

In one embodiment the method comprises providing the supply as a plurality of mixture parts each mixture part being held in a separate vessel, the mixture parts co-operating such that when mixed together the mixture parts form the settable composition.

In one embodiment the method comprises mixing the mixture parts en-route from respective separate vessels to the inflatable container.

In one embodiment the plurality of mixture parts is provided as a first part comprising a resin and a second part comprising a hardener for hardening the resin.

In one embodiment the method further comprises providing one or both of the first and second parts as a mixture of the corresponding part with a filler. The filler may be a particulate solid material.

In one embodiment the method comprises creating a recirculating flow of each mixture part which comprises filler.

In one embodiment disposing the inflatable container comprises disposing an inflatable container provided with a plurality of mutually over lying and fluidically isolated compartments.

In one embodiment inflating the inflatable container comprises filling each of the compartments sequentially one after the other.

In one embodiment inflating the inflatable container comprises filling the compartments simultaneously.

In one embodiment the transfer system is provided as a pump system.

In one embodiment the transfer system is provided as an accumulator system.

In a second aspect there is disclosed a system for supporting a submerged structure on an underwater floor comprising:
an inflatable container being disposable between a submerged structure and an underwater floor;
a submergible supply of a settable composition; and,
a submergible transfer system operable to transfer settable composition from the supply into the container.

In a third aspect there is disclosed a system for supporting a submerged structure on an underwater floor comprising:
an inflatable container being disposable between a submerged structure and an underwater floor;
a submerged supply of a settable composition; and,
a submerged transfer system operable to transfer settable composition from the supply to the container.

In one embodiment the system comprises a pressure compensator arranged to act between the supply and the transfer system to provide an over pressure to the supply effective such that in an event of a leak between the supply and the transfer system water is prevented by virtue of the over pressure from entering the supply or conduits providing fluid communication between the supply and the transfer system.

In one embodiment the supply comprises at least one pliable vessel arranged to be subjected to hydrostatic pressure when the system is submerged.

In one embodiment the system comprises first and second pliable vessels and wherein the settable composition comprises a mixture of two mixture parts, a first part being contained in the first vessel and the second part being contained in the second vessel.

In one embodiment, the system comprises a mixer for mixing the plurality of mixture parts. In use, the mixer may be configured to mix the plurality of mixture parts in a ratio of 1:1 on a volume basis.

In one embodiment the transfer system comprises one or more pumps.

In one embodiment the transfer system comprises an accumulator.

In a further aspect there is disclosed a settable composition having a compressive strength sufficient to support a submerged structure on an underwater floor, the settable composition comprising a mixture of a plurality of mixture parts, a first part comprising a resin and a second part comprising a hardener for hardening the resin.

In one embodiment, the epoxy resin may comprise between 15 and 25% by weight of the total settable composition, even between 19 and 22% by weight of the total settable composition.

In one embodiment, the hardener may comprise between up to 10% by weight of the total settable composition, even between 4 and 6% by weight of the total settable composition.

In one embodiment, the mixture comprises the first part and the second part in a ratio of 1:1 on a volume basis.

In one embodiment one or both of the first and second parts further comprises a filler. The filler may comprise between 50 and 70% by weight of the total settable composition, even between 55 and 65% by weight of the total settable composition.

In one embodiment, the filler may be a solid particulate material. In particular embodiments, the filler may be a sand such as ilmenite sand or garnet sand. The filler may have a specific gravity of greater than 2, and preferably at least 3, and moreover at least 3.5.

In another aspect there is disclosed a method of supporting a submerged structure on an underwater floor comprising the steps of:
disposing an inflatable container to lie between the submerged structure and the underwater floor;
under substantially the same pressure as the inflatable container, mixing a plurality of mixture parts of a settable composition to provide the settable composition as defined above;
inflating the inflatable container with the settable composition; and,

allowing the settable composition in the inflatable container to harden.

In one embodiment, the method comprises allowing the settable composition in the inflatable container to harden to a compressive strength of at least 0.5 MPa. A compressive strength of at least 0.5 MPa is considered sufficient for the filled inflatable container to withstand the weight of one or more further overlying inflatable bags filled with the settable composition.

In one embodiment inflating the container comprises inflating the container as successive layers of the settable composition to form a stack of layers of the settable composition, wherein a previous layer is allowed to at least partially harden prior to inflating the container with the settable composition to form a successive layer

In an alternate embodiment disposing the inflatable container comprise disposing one of a plurality of containers between the submerged structure and the underwater floor, and wherein inflating the container comprises inflating the plurality of containers in succession to form a stack of inflated containers wherein the settable composition in a previously inflated container is allowed to at least partially harden prior to inflation of another container.

### BRIEF DESCRIPTION OF THE DRAWINGS

Notwithstanding any other forms which may fall within the scope of the method and system as set forth in the Summary, specific embodiments will now be described, by way of example only, with reference to the accompanying drawings in which:

FIG. 1 is a schematic representation of a submerged structure on an underwater floor;

FIG. 2 is a schematic representation of a system for supporting a submerged structure on an underwater floor;

FIG. 3 is a schematic representation of a supply of settable composition incorporated in the system shown in FIG. 2;

FIG. 4a is a flow chart depicting a method of supporting a submerged conduit on an underwater floor utilising the system shown in FIG. 2;

FIG. 4b is a flow chart depicting in greater detail the method shown in the flow chart of FIG. 4a;

FIG. 5 is a schematic representation of a second embodiment of a system for supporting a submerged structure on an underwater floor; and

FIG. 6 is a schematics representation of third embodiment of a system for supporting a submerged structure on an underwater floor incorporating a mixture part recirculation system.

### DETAILED DESCRIPTION OF SPECIFIC EMBODIMENTS

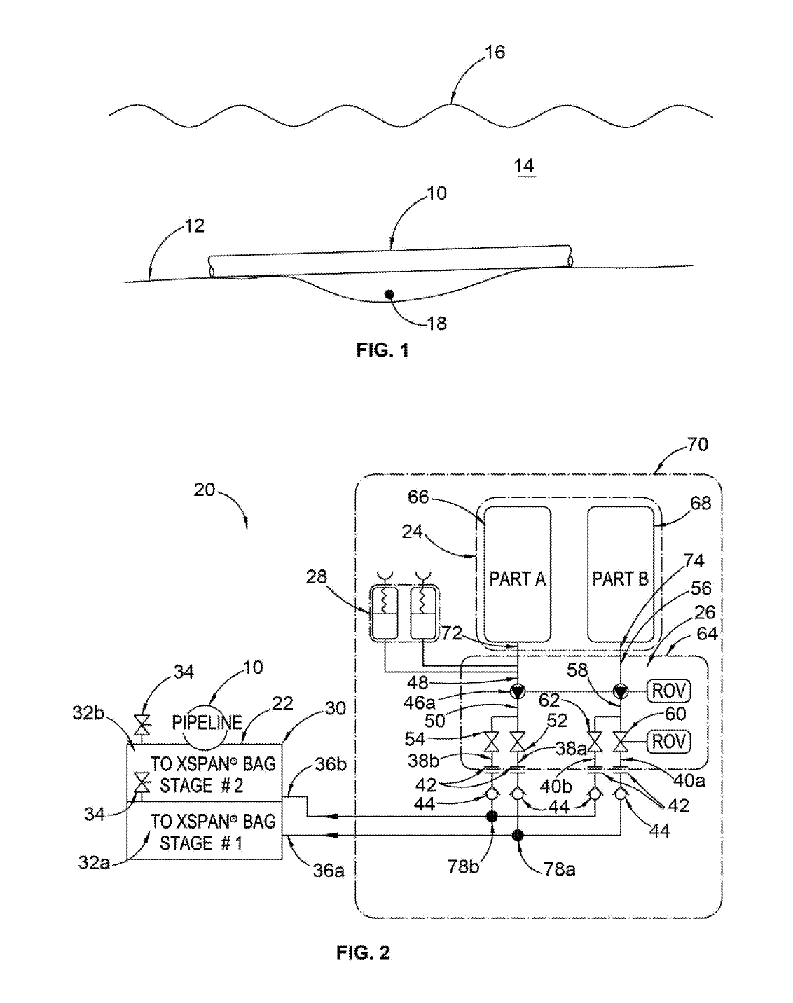

FIG. 1 illustrates a portion of a submerged structure 10 in the form of a conduit lying on an underwater floor 12 in a body of water 14. In the following description of specific embodiments of the method and system the structure 10 will be exemplified by a conduit or pipeline. The body of water 14 in which the structure 10 is submerged may be any body of water including but not limited to an ocean, a sea, a bay, a river and a lake. Depending on the nature of the body of water 14, the floor 12 may be a seabed, a river bed, a lake bed or other corresponding sub-aqua stratum. The depth of the structure beneath a surface 16 of the body of water 14 is immaterial to embodiments of the present system and method and may range from mean sea level (i.e. for example where a structure crosses a shoreline) to several kilometres.

In FIG. 1 a hollow 18 is depicted beneath the structure 10 in the floor 12. The hollow 18 may have been formed by scouring or other action and motion of water adjacent the structure 10. The structure 10 free spans the hollow 18. Gravity acts on the structure 10 including the free span portion with a tendency to bend the free span portion into the hollow 18. Water currents passing or flowing about the free span portion may cause vortex induced vibrations.

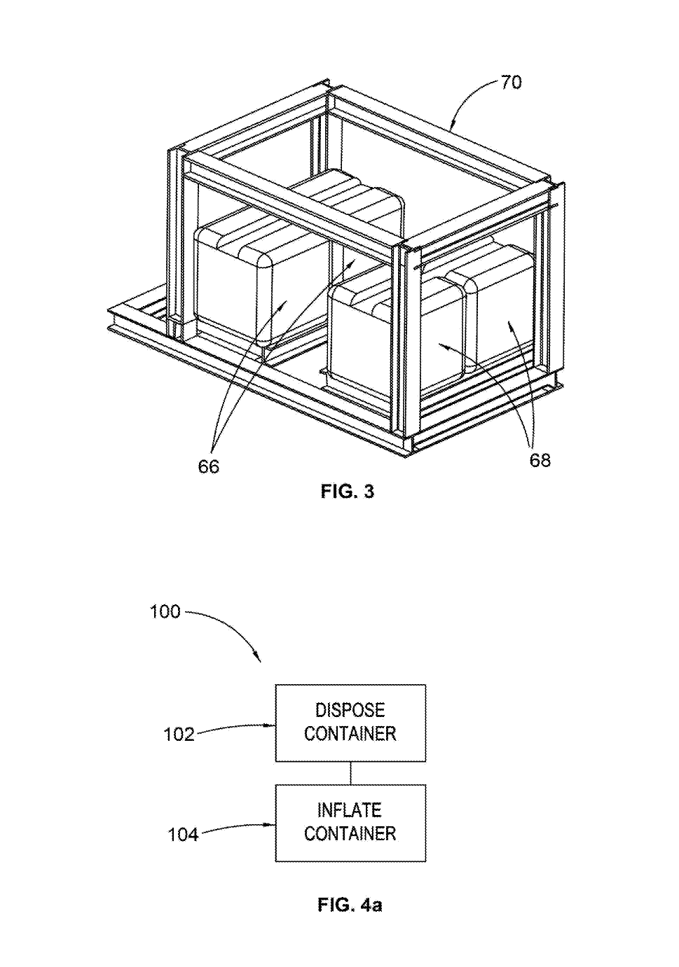

FIG. 2 is a schematic representation of a system 20 for supporting a submerged structure 10 on an underwater floor 12. The system 20 comprises an inflatable container 22, a submergible supply 24 of a settable composition and a submergible transfer system 26 operable to transfer the settable composition from the supply 24 to the container 22.

The system 20 is arranged so that the supply 24 is subjected to a hydrostatic pressure in the order of that acting on the inflatable container 22. More particularly, the system 20 is arranged so that the container 22 and the supply 24, in the absence of other influences, are subjected to substantially the same pressure. This arises due to the supply 24 and the container 22 being at or about the same depth in the body of water when in use and the material in the supply being subjected to the ambient hydrostatic pressure. Accordingly when the system 20 is in operation the transfer system 26 is required only to provide sufficient head or pressure to transfer the settable composition from the supply 24 into the container 22. The transfer system 26 is not required to overcome any substantive pressure differential between the supply 24 and the container 16.

The system 20 may also incorporate an optional pressure compensator 28 acting between the supply 24 and the transfer system 26. The pressure compensator 28 applies a slight over pressure. The over pressure only needs to be sufficient so that in the event of a leak between the supply 24 and the pump system 26 water is prevented from entering the supply 24. To provide context the overpressure may be in the order of up to 1 bar and in one example may be about ½ bar. It may also be less than ½ bar. In comparison when the system 20 is operating to inflate a container 16 at a depth of say 2000 m the ambient pressure will be in the order of 200 bar.

In this embodiment the container 22 is in the form of a bag 30 having a plurality of mutually overlying and fluidically isolated compartments 32a and 32b. The bag 30 can be brought to the sea floor 12 in a fully collapsed state. In alternate embodiments instead of a single bag with multiple overlying compartments, one or more single compartment bags may be used. If the depth of the hollow 18 required to be filled exceeds the height of an inflated single compartment bag, a plurality of single compartment bags can be stacked one on top the other.

The collapsible and inflatable nature of the bag 30 arises from the structure of the bag and the material from which it is made. The bag 30 may be made from two or more panels which are coupled together, or indeed a single bag structure, of a pliant liquid impervious material. Examples of such material include but are not limited to Hypalon™ synthetic rubber made by DuPont®; uPVC; or neoprene. The bag 30 and each of the compartments 32a and 32b have a generally rectangular prism shape when inflated with the settable composition. Each compartment 32a and 32b is provided with an independent venting/pressure relief valve 34. The valves 34 can act to vent and/or settable composition (prior to setting) to the surrounding environment to prevent overfilling and minimise the risk of rupturing the bag 30 when being filled with the material. Also when the system 20 is being deployed and while the bag 30 is being filled the valves 34 are left open. In this way the transfer system 26 does not need to push against a vacuum in the bag 30 and the head of water acting on the bag 30.

Respective conduits 36a and 36b are fixed at one end to the respective compartments 32a and 32b so that each can be filled independently of each other. Each of the conduits 36a and 36b is provided with two separate feed lines. The two feed lines 38a and 40a feed the conduit 36a feed lines; while the feed lines 38b and 40b feed the conduit 36b. Each of the feed lines is connected by respective quick connectors 42 to the transfer system 26. The quick connectors 42 enable the conduits 36 and thus the container 22 to be connected and disconnected to the pump system 26. Intermediate the respective quick connectors 42 and the conduits 36a and 36b are respective check valves 44. These valves prevent a reverse flow of settable composition. The reverse flow is a flow in the direction from the container 22 to the transfer system 26.

In this embodiment the transfer system 26 comprises two pumps 46a and 46b. The pump 46a has an inlet 48 and an outlet 50. The outlet 50 is split into two branches one of which is provided with a valve 52 and the other provided with a valve 54. The valve 52 is connectable via a corresponding quick connector 42 to the feed line 38a. The valve 54 is connectable via a corresponding quick connector 42 to the feed line 38b.

The pump 46b has an inlet 56 and an outlet 58. The outlet 58 feeds two branch lines provided with respective valves 60 and 62. The valve 60 connects to the feed line 40a via a corresponding connector 42; while the valve 62 couples to the feed line 40b via a corresponding quick connector 42. Thus the transfer system 26 comprises the two pumps 46a and 46b; the valves 52, 54, 60 and 62; and one end or part of each of the four quick connectors 42.

The transfer system 26 is also provided with an interface panel 64 to facilitate coupling of a ROV with the transfer system 26 to enable operation of the transfer system 26. The interface panel 64 enables an ROV to be sailed to the sea floor 12 to operate the system 20 by connecting to the interface panel 64. For example the ROV may be provided with a hydraulically or electrically driven shaft similar to a power take off which engages a coupling that in turn drives the pumps 46a and 46b. The ROV may also be provided with a connector block fitting a plurality of hydraulic lines that can be used to operate the valves 52, 54, 60 and 62. In addition, the ROV is provided with an arm that can connect and disconnect the quick connectors 42.

The supply 24 in this specific embodiment comprises two vessels 66 and 68 each containing a respective mixture part or component of the settable composition. Thus in this instance the settable composition is made from a mixture of the mixture parts held in the vessel 66 and 68.

The settable composition comprises a mixture of a plurality of mixture parts, a first part comprising a resin and a second part comprising a hardener for hardening the resin. In one example the settable composition comprises a two part epoxy resin system having a first part being an epoxy resin held in the vessel 66 and a second part being a hardener held in the vessel 68. In one embodiment, the mixture comprises the first part and the second part in a ratio of 1:1 on a volume basis.

In one embodiment the epoxy resin comprises a cross-linkable epoxy polymer component which is capable of cross-linking or curing at ambient temperature when combined with the second part of the settable composition. The epoxy resin may comprise between 15 and 25% by weight of the total settable composition, even between 19 and 22% by weight of the total settable composition.

Epoxy resins are well known in the art and any epoxy polymer can be used herein. Epoxy polymers are characterised by containing one or more 1,2-epoxide groups, preferably more than one and the epoxy polymer or epoxy resin is preferably a liquid at ambient temperature. The epoxy resin generally has an epoxide equivalent weight (EEW) based on solids of from about 150 to about 1,000, preferably from about to 700.

The epoxy polymer may be saturated or unsaturated cycloaliphatic, allylcyclic, or heterocyclic and may be substituted with constituents such as halogen atoms, hydroxyl groups, ether radicals, and the like. The epoxy polymer is preferably difunctional and may also be trifunctional or polyfunctional.

The epoxy resin may be used as is, may be dissolved in an appropriate solvent, or may be employed as an already formed emulsion in water or water/cosolvent blend. It will be recognized to those skilled in the art that the use of solvent or a water/cosolvent blend may be required with solid epoxy resins or extremely viscous epoxy resins. The ratio of epoxy groups in the epoxy resins to amine hydrogen in the hardener may vary widely and will depend on the nature of the epoxy resin employed and the properties necessary to meet the settable composition requirement.

Particularly preferred epoxy resins are polyacrylated epoxy resins (e.g. CAS No. 25068-38-6 and CAS No. 15825-89-5) and Bisphenol A diglycidyl ether (CAS No. 25068-38-6).

In one embodiment, the hardener comprises an epoxy curing agent capable of cross-linking the epoxy resin. The hardener may comprise up to 10% by weight of the total settable composition, even between 4 and 6% by weight of the total settable composition.

Suitable epoxy curing agents may be selected from a group comprising polyamidoamides; aliphatic and cycloaliphatic polyamine-based curing agents; and Mannich bases. Illustrative examples of aliphatic amine as epoxy curing agents include, but are not limited to, diethyltetramine (DETA), triethyltetramine (TETA), Ancamine 2758. An illustrative example of a cylcoaliphatic polyamine as an epoxy curing agent includes, but is not limited to aminoethylpiperazine. An illustrative example of a suitable Mannich base includes, but is not limited to, EH2212 by Ipox Chemicals/Amya Aus.

Preferably, the second part of the settable composition is a liquid at ambient temperature. The hardener may be used as is, may be dissolved in an appropriate solvent, or may be employed as an already formed emulsion in water or water/cosolvent blend. It will be recognized to those skilled in the art that the use of solvent or a water/cosolvent blend may be required with solid hardeners or extremely viscous hardeners.

One or both of the first and second parts may further comprise a filler. When used, the filler may be a particulate solid material. The filler may comprise between 50 and 70% by weight of the total settable composition, even between 55 and 65% by weight of the total settable composition.

One purpose of the filler is to increase the specific gravity of the settable composition delivered to the bag 30. The filler may be selected and provided in an amount so that the specific gravity of the settable composition is greater than 1 for example at least 1.2, and moreover at least 1.5. In one example the specific gravity of the settable composition may be from 1.8 to 1.9.

Fillers having a specific gravity of greater than 2, or at least 3, and moreover at least 3.5, are particularly preferred.

Examples of suitable particulate solid material include: sand such as but not limited to ilmenite sand or garnet sand; or talc powder. Generally, the particle size diameter of the filler will be chosen to ensure good dispersion of the filler through one or both of the first and second parts. For example, the mean particle size diameter of garnet sand may be 60 μm.

When the first part and/or the second part contain filler, the first part and/or second part may also comprise a flocculent or anti-settling agent to minimise the risk of the filler settling in the vessels 66, 68. Suitable examples of anti-settling agents include, but are not limited to, alginic acid, xanthan gum, bentonite powder, paraffin wax, and BYK D410 by Altana.

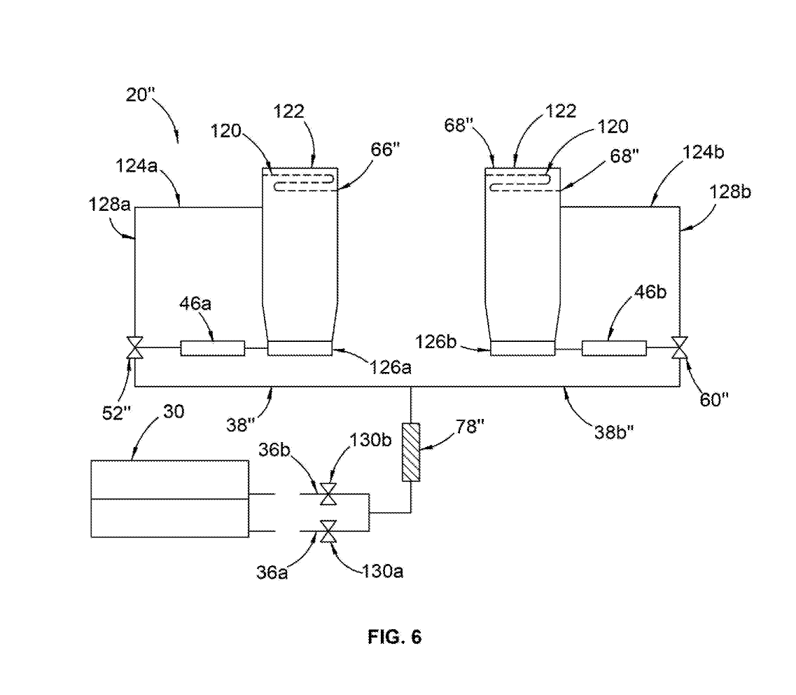

Alternately or additionally a recirculation system can be incorporated to recirculate the respective mixture part to keep a substantially uniform suspension of the filler in the resin and/or hardener prior to combining the mixture parts together. This also has the effect of avoiding or minimising settling of the filler. An example of a system 20 modified to include a recirculation system is shown in FIG. 6 and will be described later.

The second part may further comprise an accelerator to increase the cure rate of the settable composition. Illustrative examples of suitable accelerators include, but are not limited to, nonyl phenol, aminoethylpiperazine, 2,4,6-Tris(dimethylaminomethyl)phenol, and 1,8-diazabicyclo[5.4.0]undec-7-ene.

The settable composition is formulated to have a compressive strength to support the submerged structure 10 on the underwater floor 12. The compressive strength of the settable composition may be greater than 25 MPa at or after 28 days. The compressive strength of the settable composition may be at least 27 MPa at or after 28 days, and moreover at least 30 MPa at or after 28 days.

It will be appreciated that the filler may be selected and provided in an amount so that the settable composition has a compressive strength sufficient to support the submerged structure.

As a guide, the settable composition should achieve a compressive strength of 0.5 MPa after 30 minutes, 5 MPa within 24 hours and 30 MPa within 28 days. The reason for the functional requirement is that in some embodiments with a multi-compartment bag 30 the compartments 32a, 32b may be filled with the settable composition sequentially for example initially the lower compartment 32a then the overlying compartment 32b. The compartment 32a would need to achieve sufficient compressive strength of at least 0.5 MPa after 30 minutes to withstand the weight of the compartment 32b when it is filled with settable composition. Therefore the settable composition needs to set relatively rapidly. On the other hand, the settable composition should not set too quickly as it would be difficult to pump the settable composition successively into the compartments 32a, 32b after the first part and the second part are mixed as described below. As previously described instead of a multi-compartment container 30, a plurality of single compartment containers 30 may be used and stacked on each other to effectively pack a hollow 18. In this instance the containers 30 can be successively filled with the settable composition one after the other, but allowing the settable composition in a previously inflated container to at least partially harden prior to inflation of another container.

The vessels 66 and 68 can include pliable bladders or bags that are also subjected to hydrostatic pressure. The vessels 66 and 68 can be held within an intermediate bulk container (IBC) 70 (see also FIG. 3). The IBC 70 is provided with holes or is otherwise open to allow water within the body of water 14 to act on the vessels 66 and 68.

When the system 20 is in use inflating the container 22, the mixture parts from the vessels 66 and 68 are pumped by the respective pumps 46a and 46b and each mixture part will flow through the conduits 36a and 36b. To ensure mixing of the mixture parts prior to entry into the container 22, mixing chambers 78a and 78b are provided in the respective conduits 36a and 36b. The mixing chamber 78a receives and mixes: (a) the mixture part from vessels 66, which has been pumped by pump 46a and channelled through feed line 38a; with (b) the mixture part from vessel 68 which has been pumped by pump 46b and channelled through the feed line 40a. The mixed mixture parts then comprise the settable composition which flows through the conduit 36a to the container 22 and in particular the compartment 32a.

The mixture parts from vessels 66 and 68 are also mixed in the mixing chamber 78b prior to passing through the conduit 36b into the container 22 and in particular the compartment 32b. In this instance, the mixture part from vessel 66 is pumped by pump 46a and travels through the feed line 38b to the mixing chamber 78b; while the mixture part from vessel 68 is pumped by pump 46b and flows through the feed line 40b to the mixing chamber 78b.

The pressure compensator 28 is connected between the supply 24 and the transfer system 26. More particularly, the pressure compensator 28 is plumbed into supply lines 72 and 74 from the vessels 66 and 68 respectively to the inlets 48 and 56 of the pumps 46a and 46b.

Prior to use of the system 20, the IBC 70 is loaded with the vessels 66 and 68, the container 22, the transfer system 26, pressure compensator 28 and the interface panel 64. The system 20 is fully plumbed at this time so that the feed lines 38a, 38b, 40a and 40b are coupled by the quick connectors 42 to the outlet end of the pump system 26; the vessels 66 and 68 are connected to the inlet side of the transfer system 26; and the container 22 is plumbed to the conduits 36. The system 20 contained in the IBC 70 is then sailed in a marine vessel to a place of deployment.

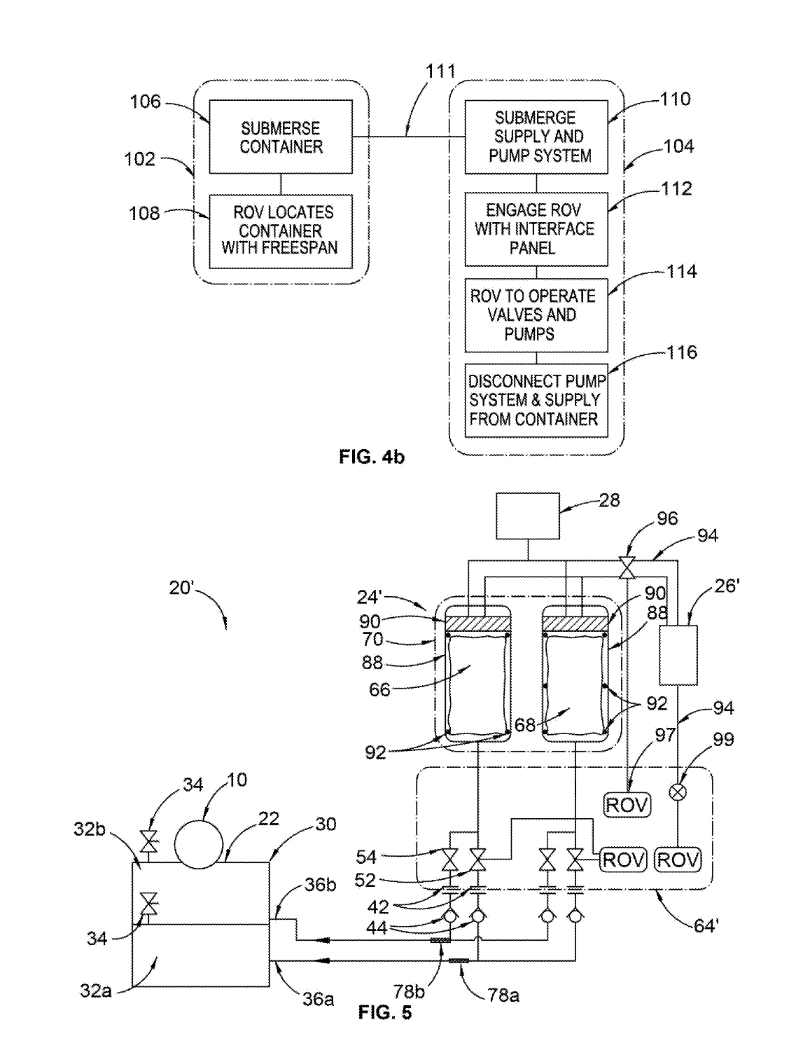

The method of use 100 of the system 20 will now be described with reference to the flow diagrams shown in FIGS. 4a and 4b. FIG. 4a depicts very broadly the method of supporting a submerged structure 10. In its broadest and simplest form the method 100 comprises a first step 102 of disposing the container 22 to lie between the submerged structure 10 and the underwater floor 12; and a second step 104 of inflating the inflatable container 22 with a settable composition from a submerged supply 24 of the settable composition.

FIG. 4b depicts the steps 102 and 104 in an expanded or more detailed manner. The step 102 itself comprises two sub-steps 106 and 108. Step 106 requires submerging the container 22 from the marine vessel to the seafloor 12. This is achieved by lowering the IBC 70 from the marine vessel to the seabed 12 using for example a winch or crane. It will be noted that the IBC 70 contains all components of the system 20 and thus all of the components are simultaneously submerged. Once the IBC 70 and thus the container 22 has reached the seabed 12, at step 108 an ROV is sailed to the seabed to locate the IBC 70 and container 22. The ROV which is remotely controlled from a surface vessel is operated to grab the container 22 and install the container 22 in the hollow 18 beneath the free span of the conduit 10. This now completes the steps required for disposing the container 22 beneath the structure 10.

The step 104 of inflating the container 22 comprises an initial step 110 of lowering or submerging the supply 24 and the pump system 26. As explained above, the supply 24 and transfer system 26 (and indeed pressure compensator 28) together with the container 22 are held in the IBC 70. Thus the step 110 is in effect accomplished simultaneously with the step 106. This is represented by the link line 111 in FIG. 4b. By submerging the supply 24 to the seabed 12 and at a location relatively near to the container 22, the supply 24 and in particular the mixture parts held within the vessels 66 and 68 are subjected to substantially the same hydrostatic pressure as the container 22.

In order to simplify the use of the system 20 the supply 24 is pre-connected to the transfer system 26 and to the container 22 via the conduits 36a and 36b and the quick connectors 42. The next stage in the inflation of the container 22 is step 112 at which the ROV is engaged with the interface panel 24. Subsequently at step 114 the ROV is remotely operated to open or otherwise control the valves 52, 54, 60 and 62; and operate the pumps 46a and 46b. If the mixing chambers 78a and 78b need to be powered the ROV also is connected to them by the interface panel 24. But this step is not required if the mixing chambers are static mixers. Further, the ROV can manipulate the valves 52, 54, 60 and 62 to inflate the separate chambers 32a and 32b sequentially or simultaneously.

Once the container 22 has been inflated, at step 116 the ROV is operated to disconnect the quick connectors 42. Thereafter, the IBC 70 with the vessels 66, 68, the transfer system 26 and the pressure compensators 28 can be returned to the marine vessel. Likewise, the ROV can be returned to the same or another marine vessel.

If it is required to support the structure 10 by use of two or more containers 22 that are disposed adjacent, or in close vicinity to, each other then the IBC 70 maybe loaded with a second or more containers 22 prior to being submerged. The first container (that is the one which is pre-connected to the supply 24 and transfer system 26) is disposed and inflated in the manner described above. Thereafter, the second and all other subsequent containers 22 can be sequentially disposed and inflated in a manner substantially identical to that described above with the only difference being that after inflation of the first container 22, the ROV is operated to disconnect the quick connectors 42 from the initially inflated container 22 and make fresh connections via the quick connectors 42 to the second and any further container 22.

Whilst a specific system and method for supporting a submerged structure have been described it should be appreciated that the system and method may be embodied in many other forms. For example the container 22 may comprise a single chamber bag. Alternately, the container 22 may comprise more than two chambers. In the event that there are more than two chambers the transfer system 26 will require modification in order to enable independent filling of the chambers. This requires additional feed lines with corresponding valves similar to the valves 52, 54, 60 and 62.

FIG. 5 depicts a further embodiment of a system 20′ for supporting a submerged structure 10 on an underwater floor 12. All of the features of the system 20′ that are the same as those in the embodiment 20 are denoted with the same reference numbers. Features which are functionally similar although structurally different are designated with the same reference number but with the addition of the prime symbol (′).

The system 20′ differs from the system 20 only by way of the configuration of the supply 24′, and the structure of the transfer system 26′. In this embodiment the supply 24′ comprises separate vessels each of which contains a pliable bag 66 and 68 for holding the mixture parts of the settable composition. However in addition the vessels 66 and 68 are contained within rigid housings 88 which also house respective pistons 90. The pistons 90 are arranged to apply pressure to the vessels 66 and 68 thereby causing the mixture parts to ultimately flow through the feed lines 38a, 38b, 40a, 40b and subsequently the conduits 36a and 36b into the respective compartments 32a and 32b of the inflatable container 22.

The rigid housings 88 are provided with openings 92 to ensure that the vessels 66 and 68 are subjected to substantially the same hydrostatic pressure as the container 22. The pistons 90 are operated by a compressed fluid, conveniently air, held within an accumulator 26′. The accumulator 26′ is coupled via a feed line 94 and a valve 96 to each of the housings 88 on a side of the respective pistons 90 opposite the vessels 66 and 68. The valve 96 is operated remotely by a ROV via connection port 97 on the interface panel 64′. The interface panel 64′ also includes a connection port 99 to enable the ROV to recharge the accumulator 26′.

The pressure compensator 28 is connected into the feed line 94 downstream of the valve 96 to apply a small over pressure to the pistons 90 and thus the vessels 66 and 68. The over pressure is in the same order as described herein above in relation to the embodiment shown in FIG. 2 namely about ½ bar. This overpressure will ensure that in the event of a leak occurring between the vessels 66 and 68 and the valves 52, 54, 60 and 62 there is no ingress of water into this portion of the system 20′. Also, in this embodiment the mixing chamber 78a′ and 78b′ are in the form of static helical mixing tubes.

The function and operation of the system 20′ is in essence identical to the system 20 described herein above. The only substantive difference now being that the ROV instead of applying torque or motive power to the pumps 46a and 46b as in system 10, controls the valve 96 to allow pressure within the accumulator 26′ to act on the pistons 90 thereby transferring of the mixture parts of the settable composition into the container 22. In this embodiment the ROV operates the valves 52, 54, 60 and 62 in the same manner as in the first embodiment and is able to connect or disconnect the quick connectors 42 as required.

The system 20′ can also use or incorporate techniques to minimise the risk of the filler settling in the vessel 66 similar to those described for the system 20. These include adding a flocculent or anti-phase separation system to the filler or plumbing a recirculation system to the system 20′ to keep a substantially uniform suspension of the filler in the resin.

FIG. 6 is a schematic representation of a further embodiment of a system 20″ for supporting a submerged structure 10 on an underwater floor 12. All of the features of the system 20″ that are the same as those in the embodiment 20 and 20′ are denoted with the same reference numbers. Features which are functionally similar although structurally different are designated with the same reference number but with the addition of the double prime symbol (″).

The system 20″ comprises two vessels 66″ and 68″ for holding the first and second mixture parts. The vessels 66″ and 68″ are formed with rigid walls and have respective pressure compensating diaphragms 120 at their respective upper ends. The pressure compensating diaphragms 120 are subject to the ambient hydrostatic pressure via holes or openings (not shown) formed in an upper wall 122 of each of the vessels. The diaphragms 120 maintain fluid separation between the respective extra mixture parts within the vessels and the external environment. The diaphragms 120 may be made of the same material as the container 30 as previously described. The diaphragms 120 are formed in a shape and configuration enabling them to transmit ambient hydrostatic pressure to the respective mixture parts within their vessels. This may be achieved, for example, by forming the diaphragms 120 of a shape and configuration that enables the diaphragms to in substance line the interior of their respective vessels. Thus when the vessels are filled, the diaphragms 120 will be disposed near the top of the respective vessel and be formed with a plurality of folds.

The system 20″ incorporates a recirculation system 124a for the vessel 66″ and a recirculation system 124b for the vessel 68″. The respective recirculation systems are preferably included when the mixture parts in the respective vessels include a filler. However if one of the mixture parts does not comprise a filler then the corresponding recirculation system may not be required. In this instance it is assumed that both the mixture parts in the vessels 66″ and 68″ comprise a filler.

The recirculation system 124a comprises an auger 126a at a bottom end of the vessel 66″. The auger 126a is in fluid communication with a pump 46a. The pump 46a has an opposite end feeding to a valve 52″. The valve 52″ controls flow of material either through a recirculation line 128a or to a feed line 38″. The feed line 38″ is in fluid communication with a static mixer 78″. The static mixer 78″ in turn is in fluid communication with the conduits 36a and 36b via respective valves 130a and 130b.

The recirculation system 124a operates by recirculating the mixture part within the vessel 66″ in a direction from vessel 66″ through the conduit 128a, pump 46a and auger 26a back into the vessel 66″. In order to achieve this recirculating flow the valve 52″ is moved or operated by a ROV to shut off communication to the feed line 38a″. By virtue of the recirculating flow the mixture part including the filler is caused to flow in an upward direction within the vessel 66″.

The recirculation system 124b is identical to the system 124a in both structure and operation. The system 124b when in use enables a recirculating of the mixture part within the vessel 68″ from an upper part of the vessel 68″ back into a lower end of the vessel 68″ through the auger 126b.

When it is required to operate the system 20″ to fill a container 30 the direction of the pumps 68a and 68b is reversed and the respective valves 52″ and 60″ moved so that the mixture parts from the respective vessels 66″ and 68″ flow through feed lines 38a″ and 38b″ to the static mixer 78″. The second mixer 78″ mixes the mixture parts and forms a suitable compound. The suitable compound can then be directed by operation of valves 130a and 130b to the container 30.

In either system embodiment the settable composition can be in the form of a self setting or curing material such as grout or cement that can be held in each of vessels 66 or 68. This simplifies the system 20/20′/20″ because there is no need to mix two separate substances prior to inflating the container 30. However setting time for the grout or cement may be longer than that for the resin.

Non-limiting examples of the settable composition will now be described.

### EXAMPLE

Tables 1-3 provide three examples of mixture parts in representative mass and volume ratios the vessels 66 and 68 which together form embodiments of the settable composition.

TABLE 1

| | Vessel 66 - Resin mixture part | | | Vessel 68 - Hardener mixture part | | | | |
|---|---|---|---|---|---|---|---|---|
| | | | anti- | | | | | anti- |
| | polyacrylated | | settling | Mannich | | | | settling |
| | epoxy resin | Filler | agent | base | NP | AEP | Filler | agent |
| Density (gr/cm3) | 1.1 | 3.6 | 1.2 | 1.0 | 0.9 | 1.0 | 3.6 | 1.2 |
| Mass (gr) | 85000.0 | 135000.0 | 1700.0 | 23800.0 | 42500.0 | 17000.0 | 103079.5 | 2499.0 |
| Volume (cm3) | 77272.7 | 37500.0 | 1465.5 | 23333.3 | 45357.5 | 17258.9 | 28633.2 | 2154.3 |

| | | |
|---|---|---|
| Total Volume (cm3) | 116238.2 | 116737.2 |

TABLE 2

| | Vessel 66 | | | | | | |
|---|---|---|---|---|---|---|---|
| | | | anti- | Vessel 68 | | | |
| | polyacrylated | | settling | | | anti-settling | |
| | epoxy resin | Filler | agent | NP | AEP | agent | Filler |
| Density (gr/cm3) | 1.1 | 3.5 | 1.2 | 0.9 | 1.0 | 1.2 | 3.5 |
| Mass (gr) | 400.0 | 450.0 | 8.0 | 200.0 | 80.0 | 8.4 | 688.1 |
| Volume (cm3) | 363.6 | 129.7 | 6.9 | 213.4 | 81.2 | 7.2 | 198.3 |

| | | |
|---|---|---|
| Total Volume | 500.2 | 500.2 |
| (cm3) | | |

TABLE 3

| | Vessel 66 | | | Vessel 68 | | | | |
|---|---|---|---|---|---|---|---|---|
| | | | anti- | | | | | anti- |
| | polyacrylated | | settling | Mannich | | | | settling |
| | epoxy resin | Filler | agent | base | NP | AEP | Filler | agent |
| density (gr/cm3) | 1100.00 | 3600.00 | 1160.00 | 1020.00 | 937.00 | 985.00 | 360.00 | 1160.00 |
| Mass (kg) | 70.00 | 120.00 | 1.40 | 19.60 | 35.00 | 14.00 | 92.23 | 2.06 |
| Volume (m3) | 0.0636 | 0.0333 | 0.0012 | 0.0192 | 0.0374 | 0.0142 | 0.0256 | 0.0018 |

| | | |
|---|---|---|
| Total Volume (m3) | 0.10 | 0.10 |

In the Tables:

Filler is garnet sand;

An example of the anti-settling agent is BYK D410 supplied by Altana;

Mannich base is a hardener/curing agent an example being EH2212 supplied by Ipox

Chemicals/Omya Aus;

NP is nonyl phenol, an accelerator;

AEP is aminoethylpiperazine.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the system and method as disclosed herein.

1. A method for supporting a submerged structure on an underwater floor comprising:
disposing an inflatable container to lie between a submerged structure and an underwater floor;
enabling transmission of ambient hydrostatic pressure to a submerged supply of a settable composition so that the settable composition is subjected to hydrostatic pressure in the order of, or substantially the same as, hydrostatic pressure acting on the inflatable container; and
inflating the inflatable container with settable composition from the submerged supply of the settable composition.

2. The method according to claim 1 wherein inflating the inflatable container comprises submerging a transfer system and associating the transfer system with the supply to selectively enable transfer of the settable composition from the supply to the inflatable container.

3. The method according to claim 2 comprising applying a slight over pressure to the supply effective such that in an event of a leak between the supply and the transfer system water is prevented by virtue of the slight over pressure from entering the supply or conduits providing fluid communication between the supply and the transfer system.

4. The method according to claim 3 wherein applying a slight over pressure comprises providing an over pressure in the order of about ½ bar.

5. The method according to claim 1 comprising operating a ROV to perform one or more of (a) remotely connect or disconnect the supply and the container; (b) control one or more valves provided in conduits facilitating fluid connection between the supply and the inflatable container; and (c) operate the transfer system to facilitate transfer of the settable composition to the container.

6. (canceled)

7. (canceled)

8. The method according to claim 1 comprising providing the supply as a plurality of mixture parts each mixture part being held in a separate vessel and mixing the mixture parts together while being submerged, the mixture parts co-operating such that when mixed together the mixture parts form the settable composition.

9. (canceled)

10. (canceled)

11. The method according to claim 8 further comprising providing one or both of the first and second parts as a mixture of the corresponding part with a filler.

12. The method according to claim 11 comprising creating a recirculating flow of each mixture part which comprises filler.

13. The method according to claim 1 wherein disposing the inflatable container comprises disposing an inflatable container provided with a plurality of mutually over lying and fluidically isolated compartments.

14. (canceled)

15. (canceled)

16. The method according to claim 2 wherein the transfer system is provided as a pump system or an accumulator system.

17. (canceled)

18. A system for supporting a submerged structure on an underwater floor comprising:
an inflatable container being disposable between a submerged structure and an underwater floor;
a submergible supply of a settable composition the submergible supply arranged to enable transmission of ambient hydrostatic pressure to settable composition within the supply so that when the supply is submerged and located near the inflatable container the settable composition is subjected to hydrostatic pressure in the order of, or substantially the same as, hydrostatic pressure acting on the inflatable container; and
a submergible transfer system operable to transfer settable composition from the supply into the container.

19. (canceled)

20. The system according to claim 18 comprising a pressure compensator arranged to act between the supply and the transfer system to provide an over pressure to the supply effective such that in an event of a leak between the supply and the transfer system water is prevented by virtue of the over pressure from entering the supply or conduits providing fluid communication between the supply and the transfer system.

21. The system according to claim 18 wherein the supply comprises at least one pliable vessel arranged to be subjected to hydrostatic pressure when the system is submerged.

22. The system according to claim 21 comprising first and second pliable vessels and wherein the settable composition comprises a mixture of two mixture parts, a first part being contained in the first vessel and the second part being contained in the second vessel.

23. The system according to claim 18 wherein the transfer system comprises (a) one or more pumps or (b) an accumulator.

24. (canceled)

25. A method of supporting a submerged structure on an underwater floor comprising the steps of:
disposing an inflatable container to lie between the submerged structure and the underwater floor:
locating a supply of settable composition underwater wherein the settable composition comprises a mixture of a plurality of mixture parts, a first part comprising a resin and a second part comprising a hardener for hardening the resin;
under substantially the same pressure as the inflatable container, mixing a plurality of mixture parts of a settable composition underwater;
inflating the inflatable container with the settable composition; and,
allowing the settable composition in the inflatable container to harden.

26. (canceled)

27. The method according to claim 25, wherein inflating the container comprises inflating the container as successive layers of the settable composition to form a stack of layers of the settable composition, wherein a previous layer is allowed to at least partially harden prior to inflating the container with the settable composition to form a successive layer

28. The method according to claim 27, wherein disposing the inflatable container comprise disposing one of a plurality of containers between the submerged structure and the underwater floor, and wherein inflating the container comprises inflating the plurality of containers in succession to form a stack of inflated containers wherein the settable composition in a previously inflated container is allowed to at least partially harden prior to inflation of another container.

29.-40. (canceled)

41. The method according to claim 25 comprising recirculating each of the mixture parts through respective vessels which contain a supply of that mixture part.

42. The method according to claim 41 wherein the recirculating comprises causing an upward flow of a mixture part through its respective vessel.
